(19) United States
(12) Patent Application Publication
(10) Pub. No.: US 2003/0046997 A1
(43) Pub. Date: Mar. 13, 2003

(54) Liquid level sensor

(76) Inventor: Clive Waller, Yarloop WA (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/214,387

(22) Filed: Aug. 8, 2002

(30) Foreign Application Priority Data
Aug. 8, 2001 (AU) PR6896

(51) Int. Cl. G01F 23/00

(52) U.S. Cl. 73/295

(57) ABSTRACT

A liquid level sensor 10 includes spaced apart first and second temperature sensor 12, 14 and a heater 16 which is closer to the first temperature sensor 12 than the second temperature sensor 14. A temperature difference sensing circuit 18 provides an indication of the difference between the temperature sensed by the first and second sensor 12, 14 and more particularly the indication as to when this difference is above a threshold level. The sensors 12 and 14 and heater 16 are disposed within an elongated tube 22 made from a thermally conductive material with sensor 12 and heater 16 a distal end 26 of the tube and the temperature sensor 14 near a proximal end 28. The tube 22 is typically disposed horizontally within a sump. Temperature sensor 14 provides an indication of ambient temperature. Sensor 12 provides an indication of the temperature near the heater 16. The difference in temperature sensed by sensors 12 and 14 is dependent on whether the tube 12 comes into contact with liquid, If so, the temperature difference is less than would be the case if the tube 12 is not contacted by liquid. This is used as the basis to determine whether or not the level of liquid within the sump is below the level of the tube 22.

### FIELD OF THE INVENTION

The present invention relates to a liquid level sensor, particularly, though not exclusively, for use in the measuring oil level within a refrigeration compressor.

### BACKGROUND OF THE INVENTION

Present refrigeration systems use a myriad of different types of sensors for providing an indication of the oil levels within compressors. Present sensors include mechanical sensors, magnetic sensors, optical sensors and proximity or ultrasonic sensors. The performance, accuracy and reliability of each of these types of sensors can be effected by the build-up of foreign matter, such as metal filings, which is quite common in the lubrication oil of compressors.

The present invention was developed with a view to providing a liquid level sensor that is substantially unaffected by the build-up of foreign matter within liquid being sensed. While embodiments of this invention are particularly well suited to application in refrigeration systems, embodiments are equally well adapted for use in any other system in which liquid level monitoring is required.

### SUMMARY OF THE INVENTION

According to the first aspects of the present invention there is provided a liquid level sensors including:

a first temperature sensor providing an indication of a first temperature;

a second temperature sensor providing an indication of a second temperature, said second temperature sensor spaced from said first temperature sensor;

a heater disposed closer to said first temperature sensor than said second temperature sensor; and,

temperature difference sensor coupled to said first and second temperature sensors providing an indication of a difference between said first and second temperatures.

Preferably said liquid level sensor further includes a housing containing said first and second sensors and said temperature sensor.

Preferably said housing includes an elongated tube with said first temperature sensor and said heater disposed near a distal end of said tube, and said second temperature sensor spaced from said first temperature sensor toward a proximal end of said tube.

Preferably said tube is made of a thermally conductive material.

Preferably said heater is electrically powered.

Preferably said heater includes one or more electrically powered heating resistors.

Preferably said first and second temperature sensors include respective platinum temperature sensing resistors.

Preferably said temperature difference sensor includes a switch which switches between an ON state and an OFF state when said temperature difference is greater than a predetermined temperature difference.

Preferably said temperature difference sensor further includes an alarm coupled to said switch to provide one or both of an audio alarm and a visual alarm when said temperature difference is greater than said predetermined temperature difference.

Preferably said temperature difference sensor includes a differential amplifier having a first input to which said first temperature sensor is coupled and a second input to which said second temperature sensor is coupled and an output to which said switch is coupled.

Preferably said liquid level sensor further includes liquid level stabilisation device for providing a sample of liquid, the level of which is to be sensed, and wherein at least said first temperature sensor is located within said liquid level stabilisation device.

Preferably said liquid level stabilisation device includes a receptacle defining a cavity and provided with a plurality of orifices for providing fluid communication between cavity and a region external of said receptacle.

Preferably said orifices are dimensioned to baffle flow of liquid into and out of said cavity in response to a change in liquid level external of said receptacle.

According to a further aspect of the present invention there is provided a method for sensing the level of a liquid within a vessel said method including at last the steps of:

providing first and second temperature sensors at spaced locations, said first temperature sensor disposed to provide an indication of internal vessel temperature and said second sensor disposed to provide an indication of ambient temperature;

providing a heater nearer said first sensor and operating said heater to cause localised heating near said first temperature sensor; and,

sensing for a predetermined difference in temperature sensed by said first and second temperature sensors.

### BRIEF DESCRIPTION OF THE DRAWINGS

FIG. 1 is a schematic representation of a first embodiment of the present invention;

FIG. 2 is a circuit diagram of a circuit incorporated in the sensor depicted in FIG. 1;

FIG. 3 is a section view of a further embodiment of the present invention; and

FIG. 4 is an end view of the embodiment of FIG. 3.

### DETAILED DESCRIPTION OF THE PREFERRED EMBODIMENTS

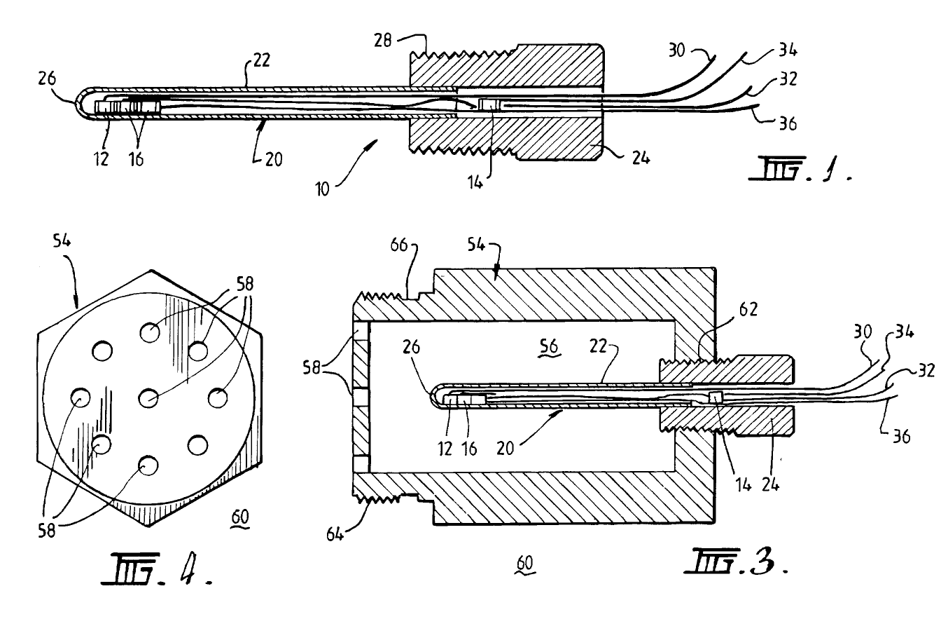

With reference to the accompanying drawings, the liquid level sensor 10 includes a first temperature sensor 12, typically in the form of platinum temperature sensing resistor, for providing an indication or signal representative of a first temperate, and a second temperature sensor 14, also in the form of a platinum temperature sensing resistor, for providing an indication or signal representative of a second temperature. As is apparent from FIG. 1, the sensors 12 and 14 are spaced apart. The liquid level sensor 10 also includes a heater in the form of a plurality (in this case two) heating resistors 16. The heating resistor 16 are disposed closer to the first sensor 12 than second sensor 14. Indeed, the heating resistor 16 are adjacent the temperature sensor 12. The liquid level sensor 10 further includes a temperature difference sensor in the form of sub-circuit 18 (shown in FIG. 2) which is coupled to the first and second temperature sensors 12, 14 and provides an indication of a difference between the first and second temperatures sensed by the sensors 12 and 14 respectively.

In the physical realisation of the sensor 10 depicted in FIG. 1, a housing 20, which includes an elongated tube 22 with a threaded ferrule 24, is provided for housing the sensors 12 and 14 and the heater 16. The temperature sensor 12 and heater 16 are disposed inside the tube 22 near its distal end 26. Ideally the tube 22 and ferrule 24 are made of a thermally conductive material such as aluminium. The second temperature sensor 14 is disposed within the ferrule 24 near a proximal end 28 of a tube. Electrical conductors 30, 32, 34 and 36 couple the sensors 12, 14 and heaters 16 into the circuit 18.

Referring specifically to FIG. 2, the heating resistor 16 are in the form of series coupled 220 _{Ω} resistors R1 and R2 which are coupled across 12 volt DC power rails 38 and 40. The temperature sensor 12 is coupled in series with a fixed 6.8 k_{Ω} resistor R3 and a 1 k_{Ω} trimming resistor R4 between the rails 38 and 40. The temperature sensor 14 is coupled in series with a fixed 6.8 k_{Ω} resistor R5 between the voltages rails 38 and 40.

The temperature sensing circuit 18 includes a differential amplifier 42 which has its positive input 44 coupled between tie temperature sensor 12 and the resistor R3, and its negative input 46 coupled between the temperature sensor 14 and the resistor R5. The output 48 of the amplifier 42 drives a switch in the form of transistor 50 which has its collector series coupled with a relay 52 and subsequently the voltage rail 38. The emitter of transistor 50 is coupled directly to the rail 40.

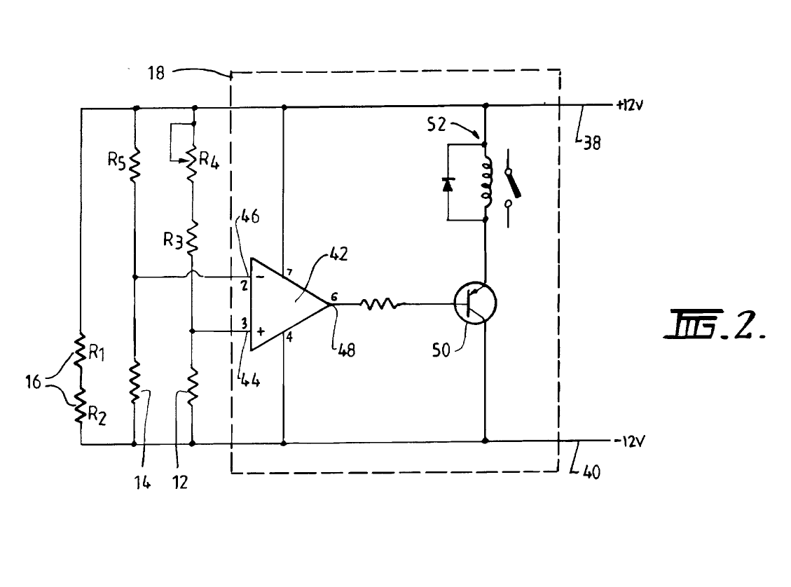

FIGS. 3 and 4 depict a further embodiment or modification of the liquid level sensor 10, In this embodiment, the sensor 10 includes a liquid level stabilisation device in the form of a receptacle 54. The receptacle 54 provides a sample of liquid, the level of which is to be sensed by the device 10. In this regard, the receptacle 54 defines a cavity 56 for holding the sample of liquid and is provided with a plurality of orifices 58 which provide fluid communication between the cavity 56 and a region 60 external of the receptacle 54.

The incorporation of the receptacle 54 is beneficial, for example, when the device 10 is used in the sump of a refrigeration compressor. Due to the inherent mechanics of such sumps, it is common for any oil therein to be splashed within the sump. Indeed, this is beneficial to the lubrication of the sump itself. Nevertheless, the splash of liquid onto the housing 20 when the liquid level may be well below the level of the housing 20 may lead to false triggering by cooling the distal end 26 even though the housing 20 may be well above the level of liquid within the sump.

The orifices 58 can be dimensioned to baffle the flow of liquid into and out of the cavity 56 in response to a change in liquid level in the external region 60. In this way, the receptacle 54 provides a further time delay and also acts to shield the housing 20 from splash contact with liquid which may trigger false readings relating to liquid level. Alternatively the orifices 58 may be dimensioned to allow flow of liquid into and out of the cavity 58 substantially with variations in liquid level. In such a situation the liquid level stabilisation device ie, the receptacle, simply acts as a splash guard to the housing 20.

The receptacle 54 is provided at one end with a thread hole 62 into which the ferrule 24 can be screwed. An opposite end of the receptacle 54 is provided with a stepped decrease in outer diameter aid an external thread 64 to allow screw coupling to a corresponding thread hole in a sump. An annular groove 66 is formed inwardly of the thread 64 for receiving an o-ring seal (not shown).

The operation of the liquid level sensor 10 will now be described.

Typically, the sensor 10 would be screwed into a tapped hole of a sump in a refrigeration compressor (not shown). This is effected by the screw thread provided on the ferrule 24. The tube 22 extends into this sump in a substantially horizontal plane with sensor 12 providing a temperature reference internal of the sump and sensor 14 providing a reference to ambient temperature. During the operation, the heating resistors 16 generate localised heating adjacent the sensor 12. If the oil level within the sump is sufficiently low so as to not contact the tube 12, the localised temperature around the heater 14 and thus the sensor 12 will rise by about 10° C. This produces a difference in voltage levels at the inputs 44 and 46 of the amplifier 42. Provided this difference is above a threshold level set by adjustment of trimming resistor R4, the output 48 of the differential amplifier 42 will go high turning ON the transistor 50 allowing the current to flow through the relay 52. The relay 52 may be coupled to an alarm (not shown) which may include an audio and/or a visual alarm. The alarm is triggered by the temperature difference between sensors 12 and 14 being greater than a predetermined difference. This, in turn, is directly related to the liquid level within the sump. This relation follows from the heat dissipation provided by liquid when in contact with the tube 22. When the liquid level within the sump is at a level sufficient to contact the tube 22, it conducts heat generated by the heating resistors 16 so that the temperature difference sensed between the sensors 12 and 14 does not exceed the predetermined level required to change the state of the switch 50.

Initial tests have indicated that when the proximal end 26 is immersed in oil, the temperature difference between sensors 12 and 14 is approximately 4° C. The operational amplifier 42 can be biased to ensure that it does not provide a high output at 48 unless the voltage difference at inputs 44 and 46 is greater than would exist for a 4° C. difference in temperature sensed by the sensors 12 and 14.

Due to thermal lag in the device 10, changes in the relative temperature between sensors 12 and 14 occur relatively slowly, providing an inbuilt hysteresis which may be particularly useful in various application. In a primary example, when the device 10 is used in oil level protection for refrigeration compressors, the device 10 allows a compressor to start on immediate application of power where the oil level typically is low (for example below the level of the tube 12) because the temperature difference between sensors 12 and 14 will take some time (e.g. a minute) to reach the level required to change the state of the switch (transistor) 50. After this time, if the distal tube 22 remains uncovered with oil the switch 50 will be turned ON closing the relay 52 and activating an alarm. If however the tube 22 is contacted by or becomes covered with oil, the corresponding heat dissipation will prevent the temperature difference building to a level which would turn ON the switch 50 thus allowing the compressor to continue to run. In this way, the device 10 allows for intermittent or transient changes in oil level without tripping.

The temperature difference required to cause a change in state of the transistor 50 can be adjusted by way of the trimming resistor R4.

The device 10 utilises two linear sensors 12 and 14, which allow operation over a large temperature range. This is not possible with a single thermistor system which is widely used in liquid level detection.

Now that an embodiment of the liquid level sensor 10 has been described in detail it will be apparent to those skilled in the relevant arts that numerous modifications and variations may be made without departing from the basic inventive concepts. For example, the device 10 can be formed with a plurality of first heat sensors 12 and heaters 16 disposed at different horizontal levels coupled to separate corresponding differential amplifiers similar to amplifier 42 each of which also receives an input from a common ambient sensor 14 for providing an indication of incremental changes in liquid level. In addition, while the preferred embodiment depicts the use of a tube 22 for housing the sensor 12 and heater 16, this is not absolutely essential and these components may be simply attached to a support such as a length of circuit board or a ceramic substrate. In addition, as with most electrical circuits, each of the components depicted in the second FIG. 2 can be replaced with other components which perform a like function. Further, the receptacle 54 could be in the form of a simple, open ended tube or sleeve over the tube 22 to provide protection from liquid splashing thereonto.

All such modifications and variations are deemed to be within the scope of the present invention the nature of which is to be determined from the above description, and the appended claims.

The claims defining the invention are as follows:

1. A liquid level sensors including:
a first temperature sensor providing an indication of a first temperature;
a second temperature sensor providing an indication of a second temperature, said second temperature sensor spaced from said first temperature sensor;
a heater disposed closer to said first temperature sensor than said second temperature sensor; and,
temperature difference sensor coupled, to said first and second temperature sensors providing an indication of a difference between said first and second temperatures.

2. The liquid level sensor according to claim 1 including a housing containing said first and second sensors and said temperature sensor.

3. The liquid level sensor according to claim 2 wherein said housing includes an elongated tube with said first temperature sensor and said heater disposed near a distal end of said tube, and said second temperature sensor spaced from said first temperature sensor toward a proximal end of said tube.

4. The liquid level sensor according to claim 3 wherein said tube is made of a thermally conductive material.

5. The liquid level sensor according to claim 1 wherein said heater is electrically powered.

6. The liquid level sensor according to claim 5 wherein said heater includes one or more electrically powered heating resistors.

7. The liquid level sensor according to claim 1 wherein said first and second temperature sensors include respective platinum temperature sensing resistors.

8. The liquid level sensor according to claim 1 wherein said temperature difference sensor includes a switch which switches between an ON state and an OFF state when said temperature difference is greater than a predetermined temperature difference.

9. The liquid level sensor according to claim 8 wherein said temperature difference sensor further includes an alarm coupled to said switch to provide one or both of an audio alarm and a visual alarm when said temperature difference is greater than said predetermined temperature difference.

10. The liquid level sensor according to claim 9 wherein said temperature difference sensor includes a differential amplifier having a first input to which said first temperature sensor is coupled and a second input to which said second temperature sensor is coupled and an output to which said switch is coupled.

11. The liquid level sensor according to claim 1 including a liquid level stabilisation device for providing a sample of liquid, the level of which is to be sensed, and wherein at least said first temperature sensor is located within said liquid level stabilisation device.

12. The liquid level sensor according to claim 11 wherein said liquid level stabilisation device includes a receptacle defining a cavity and provided with a plurality of orifices for providing fluid communication between cavity and a region external of said receptacle.

13. The liquid level sensor according to claim 12 wherein said orifices are dimensioned to baffle flow of liquid into and out of said cavity in response to a change in liquid level external of said receptacle.

14. A method for sensing the level of a liquid within a vessel said method including at last the steps of:
providing first and second temperature sensors at spaced locations, said first temperature sensor disposed to provide an indication of internal vessel temperature and said second sensor disposed to provide an indication of ambient temperature;
providing a heater nearer said first sensor and operating said heater to cause localised heating near said first temperature sensor; and,
sensing for a predetermined difference in temperature sensed by said first and second temperature sensors.
